(19) United States
(12) Patent Application Publication
(10) Pub. No.: US 2014/0126915 A1
(43) Pub. Date: May 8, 2014

(54) METHOD OF REDUCING THE MODAL GROUP DELAY IN A MULTIMODE TRANSMISSION SYSTEM

(71) Applicants: Lars Gruner-Nielsen, Copenhagen (DK); Sander Jansen, Munich (DE); Poul Kristensen, Valby (DK); Dirk Van Den Borne, Munchen (DE); Andrew Ellis, Cheshire (GB)

(72) Inventors: Lars Gruner-Nielsen, Copenhagen (DK); Sander Jansen, Munich (DE); Poul Kristensen, Valby (DK); Dirk Van Den Borne, Munchen (DE); Andrew Ellis, Cheshire (GB)

(21) Appl. No.: 14/127,801

(22) PCT Filed: Jul. 2, 2012
(86) PCT No.: PCT/US12/45323

§ 371 Date: Jan. 24, 2014

(30) Foreign Application Priority Data
Jun. 30, 2011 (EP) 11172133.8

(51) Int. Cl. H04B 10/2581

(52) U.S. Cl. CPC H04B 10/2581
USPC 398/143; 398/200

(57) ABSTRACT

Systems and methods for reducing modal group delay when transmitting a plurality of optical signals over a transmission line that supports a plurality of modes are disclosed. The modes are converted at a plurality of positions along the transmission line so the signals in the end have minimal group delay. The method comprises the steps of receiving N number of optical signals into a multimode fiber having at least N modes, transmitting each of N signals into a mode of the at least N modes of the multimode fiber, and converting each of the N modes into another of the N modes at N positions along the transmission line, such that the net modal group delay generated between the N signals along the transmission line is minimized.

### CROSS REFERENCE TO RELATED APPLICATIONS

The present application claims priority to European Provisional Patent Application No. 11172133.8, entitled “METHOD OF REDUCING THE MODAL GROUP DELAY IN A MULTIMODE TRANSMISSION SYSTEM,” filed Jun. 30, 2011, the disclosure of which is incorporated by reference herein in its entirety.

### FIELD OF THE INVENTION

The invention relates to an optical communication system and to a method of processing data for optical networks. In particular, the invention relates to a modal delay compensation scheme.

### BACKGROUND OF THE INVENTION

With the continuing growth of demand for bandwidth, fiber optic transmission systems will inherently run into a capacity crunch on single mode fiber. The spectral efficiency of networks to date is practically limited to about 2 b/s/Hz. In order to scale to higher spectral efficiencies, a denser constellation size than quadrature phase shift keying, QPSK, is required. However, a denser constellation will result in an increase in required optical signal to noise ratio, OSNR, and a reduction of the nonlinear tolerance. As a result, when scaling to denser constellation sizes, the feasible transmission distance is substantially decreased, adding significant cost to the network.

Recently multimode fibers, including few mode fibers, have been proposed to significantly extend the nonlinear tolerance of the transmission system. In addition, these fibers can be used to increase the number of channels that can be transmitted through mode division multiplexing and multiple input multiple output, MIMO processing at the receiver. However, many challenges still remain before multimode transmission can be realized. One of the main problems for the realization of long haul transmission over multimode fiber is to cope with the difference in propagation group velocity or group delay between the modes. The delay between these modes makes it practically impossible to perform MIMO equalization at the receiver for long haul systems.

A promising method to realize higher capacities is to use fibers that support more than one single mode. One way of designing such multimode fibers is to significantly increase the core size compared to that of conventional single mode fibers, which will result in a higher effective area and consequently, a higher nonlinear tolerance. In addition, these fibers support more than one propagation mode, which allows the use of mode division multiplexing.

The principle of mode division multiplexing is shown in FIG. 1. In this example, a 2-mode MIMO transmission system 100 is shown. At a transmitter 114, a single laser 102 is used to generate two polarization multiplexed signals 104, 106. The modulation format of these two signals can freely be chosen. After modulation, these signals are coupled into a multimode fiber 108. Many different methods exist to launch multiple signals into a multimode fiber, such as fiber 108. In the shown example, spatial separation is used in order to maximize the orthogonality of the two launched signals. It's worthwhile to mention that the signals do not necessarily need to be launched exactly into the two modes of the fiber: as long as the launching positions cause the signals to propagate in an orthogonal manner the capacity of the system can be maximized.

At the receiver 116, the main challenge is to receive the complete signal. In this example the multimode fiber 108 is coupled to two single mode fibers 110, 112. Please note that both single mode fibers will contain parts of the transmitted signal. As such, MIMO processing after coherent detection is required to separate the two launched modes again. The MIMO equalizer works only for a limited delay between the propagation modes. Thus, an important requirement for the receiver to work is that the delay between the different propagation modes is limited. This poses severe limitations to multimode fiber transmission.

The problem to be solved is to overcome the disadvantages stated above and in particular to provide a solution that significantly reduces the modal delay between modes in a multimode transmission system.

### SUMMARY OF THE INVENTION

In order to overcome the above-described need in the art, the present invention discloses a method for reducing modal group delay when transmitting optical signals over an optical fiber, the optical fiber having at least a first and a second mode of transmission, the method comprising the steps of transmitting a first optical signal in the first mode of transmission over a first portion of the optical fiber, transmitting a second optical signal in the second mode of transmission over the first portion of the optical fiber, converting the first mode of transmission to the second mode of transmission, and converting the second mode of transmission to the first mode of transmission, transmitting the first optical signal in the second mode of transmission over a second portion of the optical fiber, and transmitting the second optical signal in the first mode of transmission over the second portion of the optical fiber, thereby minimizing any difference in modal delay between the first and second optical signals.

In a further embodiment, the conversion of the first mode of transmission to the second mode of transmission and the conversion of the second mode of transmission to the first mode of transmission occurs along a length or span of the fiber, for example, at the middle of the span of fiber. Alternately, the conversion may occur at an amplifier site.

In a next embodiment of the invention, the first portion of the optical fiber has substantially the same transmission characteristics as the second portion of the optical fiber.

In another embodiment, a method for reducing modal group delay when transmitting a plurality of optical signals over a transmission line that supports a plurality of modes is disclosed. The modes are converted at a plurality of positions along the transmission line such that, upon reaching an end receiver, the signals will experience approximately a minimal group delay. The method comprises the steps of receiving N number of optical signals into a multimode fiber having at least N modes, transmitting each of N signals into each of the at least N modes of the multimode fiber, and converting each of the N modes into a different mode at N positions along the transmission line, such that the N signals the net modal group delay along the transmission line is minimized.

A further embodiment of the present invention includes a transmission link for transmitting N number of optical signals with minimal modal group delay. The system comprises a transmission line having at least one multimode fiber with N number of modes, and N number of mode converters located at N positions along the transmission line. A further aspect of this embodiment includes the at least one multimode fiber being a multimode fiber.

These methods provide the following advantages:
a) A significant reduction in modal delay between modes in a multimode transmission system.
b) A significant reduction in the digital signal processing, DSP, required to implement long haul MIMO transmission over multimode fiber
c) Such methods have relatively broad applications and can be easily implemented.

### BRIEF DESCRIPTION OF THE DRAWINGS

The invention is explained by way of example in more detail below with the aid of the attached drawings.

FIG. 1 is a schematic representation of a multimode transmission system.

FIG. 2 is a schematic representation of a mode conversion system according to an embodiment of the invention.

FIG. 3 is a schematic representation of a mode conversion system according to another embodiment of the invention.

### DESCRIPTION OF THE INVENTION

Illustrative embodiments will now be described with reference to the accompanying drawings to disclose the teachings of the present invention. While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

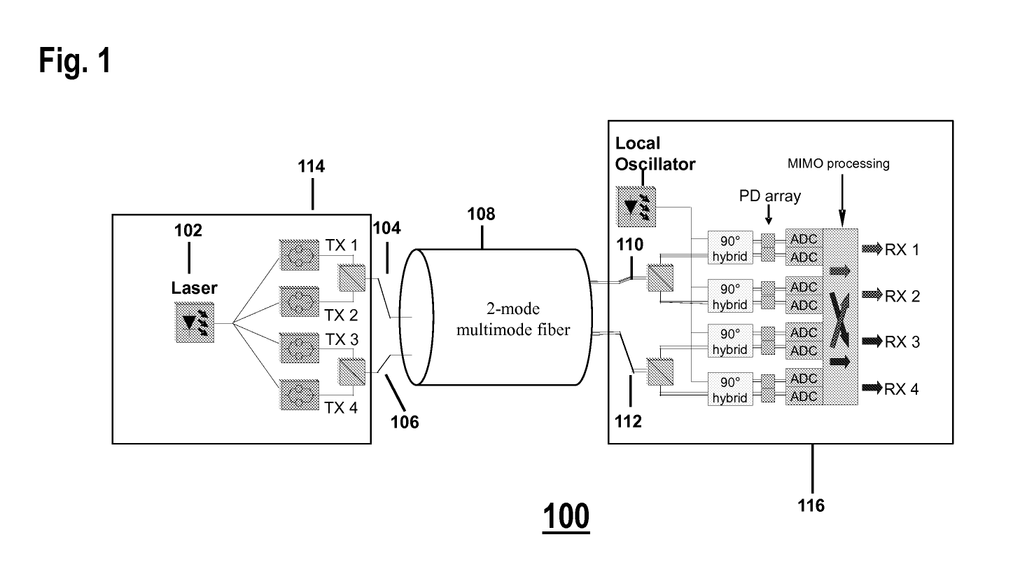

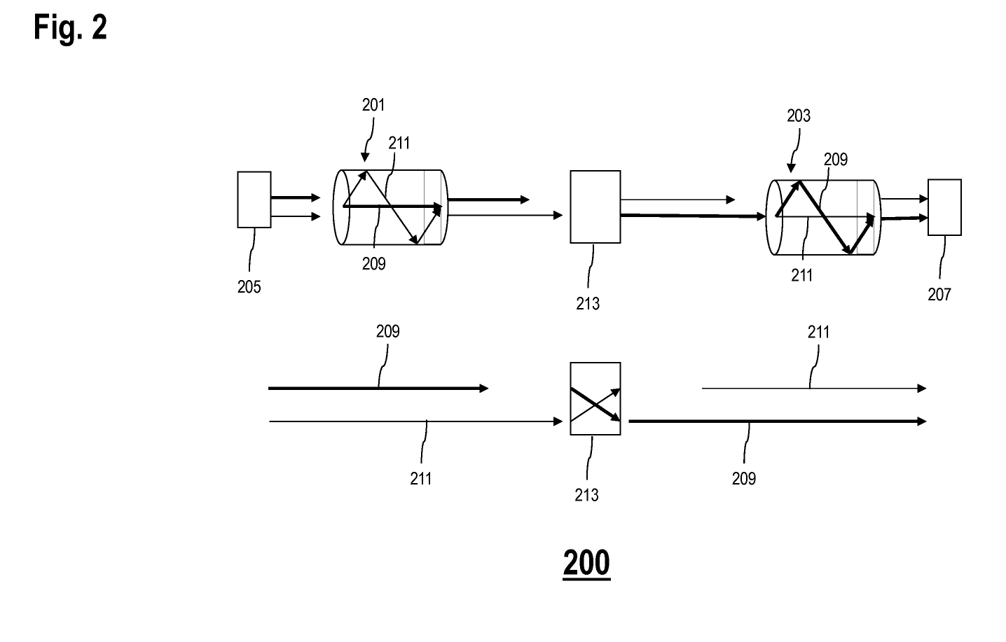

In order to mitigate modal group delay, a modal delay compensation scheme which includes mode conversion is disclosed. An exemplary embodiment of the invention is described using the 2-in, 2-out multimode transmission system shown in FIG. 1. The concept of mode conversion is illustrated in FIG. 2. In this figure, transmission link 200 comprises two fiber propagation segments, namely the first 201 and the second 203, a transmitter 205 (similar to transmitter 114 in FIG. 1), a mode converter 213, and a receiver 207 (similar to receiver 116 in FIG. 1). At the transmitter 205, two signals are launched into two separate modes of the fiber, namely a first signal 209, which is launched into the first mode and a second signal 211, which is launched into the second mode. As shown, the second mode propagates slower than the first mode. This creates a propagation or modal delay between the two signals 209, 211. In order to mitigate this delay, signals 209, 211 are converted by means of a mode converter 213 such that in the second segment 203 of the transmission link, the delay between the two signals 209, 211 is compensated. As a result, any net modal delay between the two signals is minimal after transmission. A further aspect of this embodiment includes the first fiber segment 201 and the second fiber segment 203 having substantially the same transmission characteristics in to support minimizing the modal group delay.

A challenge with exchanging the modes in the middle of a link is that in dynamically switched, meshed networks, the middle point of a link is not always on one defined point. As such, an alternative solution can be to exchange modes in the middle of every single fiber span. For transmission systems that support more than two modes, it is possible to convert all the modes at multiple places along the transmission line such that the average group velocity of the modes is approximately the same. Specifically, optical signals are transmitted over a multimode optical fiber transmission line, the multimode fiber having N modes of transmission, such that the multimode fiber receives N optical signals from N sources. Each of the N signals is received in each of the N modes of the multimode fiber.

As the modes propagate along the transmission line, modal group delay builds between the modes for the reasons previously discussed. To compensate for such delay, the N modes are each converted to a different mode within the N group, each conversion occurring at a position along the transmission line, for a total of N positions, in order to equalize the difference in group velocity between the modes. Implementing such a method provides that at the end of the transmission line, each of the N optical signals will arrive approximately simultaneously (that is, at the same time).

Moreover, it is possible to compensate for the delays by separating the modes at the receiver and inserting optical or electrical delay lines. The delay of all modes depends on the transmission distance and fiber type.

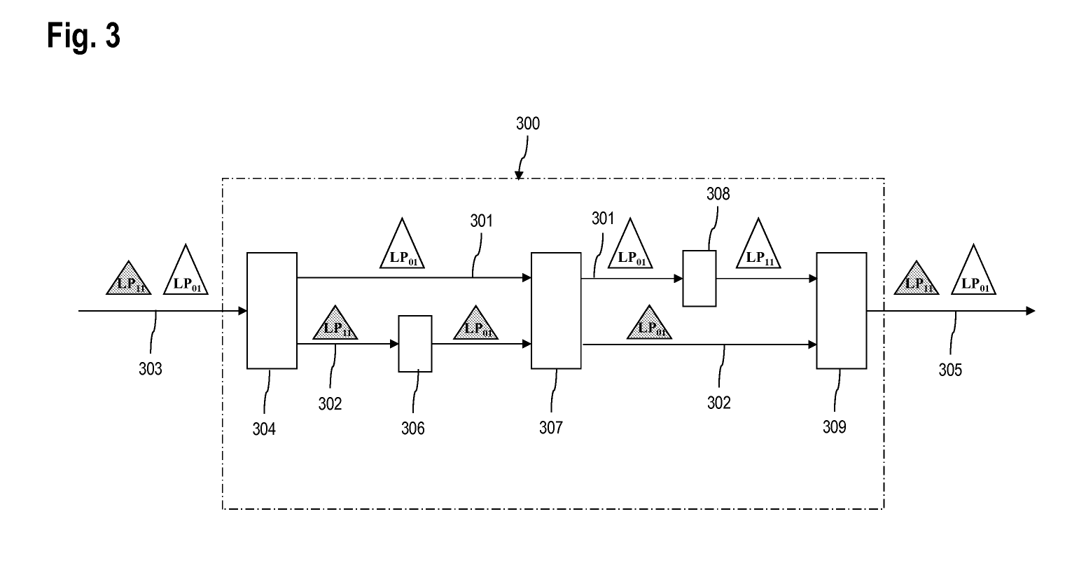

Assuming the mode coupling is predominantly associated with fiber interfaces, multimode optical amplifiers, etc., for each input signal, the output of a single span of transmission fiber will consist of a superposition of pulses, one pulse corresponding to each fiber mode. In one embodiment of the invention, the modes are demodulated at each amplifier site, and exchanged, as shown in an exemplary embodiment in FIG. 3.

In FIG. 3, a network element 300, such as an amplifier site, along a transmission line is shown. An optical signal propagates through a multimode fiber 303 in a first mode LP₀₁ and a second mode LP₁₁ into the network element 300. As the modes reach a demultiplexer 304 (for example, a multi-mode coupler), they are demultiplexed between multimode fibers 301 and 302. While the first mode LP₀₁ goes straight through the first fiber 301, the second mode LP₁₁ crosses a mode converter 306 along the second fiber 302, and thereby the second mode LP₁₁ is converted to the first mode LP₀₁. Amplification, such as erbium-doped fiber amplification, then occurs at 307. The converted first mode LP₀₁ goes straight through the first fiber 302 and then crosses a mode converter 308 along the first fiber 301, which converts the first mode LP₀₁ to the second mode LP₁₁. Fibers 301 and 303 then go through a multiplexer 309 and the pulses exit the network element 300 through an output multimode fiber 305. At the output of the network element 300, the two pulses have been amplified and have swapped modes.

This mode exchange reduces the accumulation of differential mode delay from a linear accumulation to a random walk, or may even eliminate the differential mode delay completely in certain circumstances.

In a more general case, multimode fibers can be used to guide and convert a plurality of modes LP_{m,n}, or N modes, where N is equal to or greater than 2. The number of guided LP_{m,n} modes can be found by solving the scalar wave equation for the refractive index profile of the multimode fiber. While LP₀₁ represents the fundamental mode, it is important to understand that each LP_{m,n} mode actually consists of two or four degenerate modes. When m=0, the mode is two-fold degenerate corresponding to two independent states of polarization. However, when m≧1, the mode is four-fold degenerate, having two independent spatial states, with each spatial state having two independent states of polarization. In a mode division multiplexed system, one may chose several options in using the modes:
1. Send only one optical signal per LP-mode.
2. Send one signal per each polarization of the LP-mode (two signals per mode).
3. For the LPₘₙ modes with m≧1, send one signal per spatial state (two signals per mode).
4. For the LPₘₙ modes with m≧1, send one signal per spatial state and one for each polarization state (four signals per mode).

The description so far has assumed selecting option 1 or 2. However, for options 3 and 4, special precaution must be taken. Currently known methods for mode conversion, only work for one spatial state of the LP_{m,n} modes with m≧1. An embodiment of the present invention describes mode conversion for a system using 3 modes, for example, the fundamental mode LP₀₁, and the two spatial states of higher order mode LP₁₁, which are denoted as LP_{11A} and LP_{11B}.

As a pulse or optical signal propagates through a multimode fiber in a transmission line, the LP₀₁ and LP_{11A} modes will convert or exchange places at a position of about one-third of a total length of the propagation path (between a transmitter and a receiver, for example). The LP_{11B}, mode remains unaffected until all three modes reach a position that is about two-thirds of the total path length. At this point, the LP₀₁ and LP_{11B} modes will convert or exchange positions. The inventive system and methods thereby allow for all three modes to arrive at a desired end point having little to no modal group delay.

As such, these methods and systems can be applied to a number N of optical signals propagating through a transmission line in N modes, where the system comprises N transmitters for generating the N signals, and N mode converters placed along the transmission line for converting each of the N modes in order to minimize any modal group delay between the N modes at the end of the transmission line. One aspect of this embodiment includes placing the N mode converters at N positions along the transmission line such that the N positions are approximately equidistant between one another. That is, the N mode converters are positioned evenly along the transmission line, between spans of multimode fiber.

Several technologies exist that can be used to realize mode conversion of the co-propagating spatial modes of a multimode fiber. Such mode converters can broadly be classified in to two classes: transverse and longitudinal transformers. Holographic plates and phase sensitive elements are examples of transverse transformers whereas long period fiber gratings are an example of a longitudinal transformer.

Long period fiber gratings (LPG) couple light from one mode into another by means of a periodic perturbation. The periodicity of the perturbation is essentially the period of the beat between two spatial modes. This perturbation can be implemented by several means such as, periodic exposure with UV-light, periodic exposure with a CO₂ laser, periodic exposure with heat, or periodic perturbation with a mechanical grating. The perturbation can be either azimuthally symmetric or asymmetric. In the case of an azimuthally symmetric perturbation, modes having the same symmetry will couple. In the case of an azimuthally asymmetric perturbation, modes having different symmetry or asymmetry will couple.

The coupling amplitude A can be written as an integral over the two modes and the periodic perturbation.

$$A = {\int }_{0}^{{r}_{fiber}} {\int }_{0}^{2 π} {E}_{1} ( r , ϕ ) {P}_{r ϕ} ( r , ϕ ) {E}_{2}^{*} ( r , ϕ ) r d r d ϕ {\int }_{0}^{{L}_{LPG}} {e}^{{iβ}_{1} z} {P}_{z} ( z ) {e}^{{iβ}_{2} z} d z$$

Where E₁(r,φ) and E*₂(r,φ) are the transverse part of the electric field and the complex conjugate of the transverse part of the electric field of the two modes while β₁,β₂ are the propagation constants of the two modes. The perturbation is assumed to be described by the product P_{rφ}(r,φ)P_{z}(z). Thus the function P_{z}(z) describes the periodicity of the perturbation. It is possible to obtain a phase matching condition, by requiring that also the last integral should be non-vanishing, thus:

$${\int }_{0}^{{L}_{LPG}} {e}^{{iβ}_{1} z} {P}_{z} ( z ) {e}^{{iβ}_{2} z} d z \neq 0 ⇒ abs ( {β}_{1} - {β}_{2} ) \approx \frac{2 π}{Λ}$$

Where Λ is the period of the LPG and the integral is over the length of the LPG,L_{LPG}. When the phase matching condition is fulfilled then light is transferred from the first mode to the second mode and since the amplitude integral is symmetric in the two modes, light from the first mode is also transferred to the second mode. Long period gratings thus represent a low loss (<0.5 dB) efficient device.

Alternatively it is possible to transfer light between modes using a transverse transformer which usually consist of two lenses collimating the light from the input fiber on to a wave front manipulating element and then focusing the light onto the output fiber end. The role of the wave front manipulating element is to transform the incoming electric field Eᵢₙ(r,φ,z)=\sqrt{Iᵢₙ(r,φ,z)}e^{iφ}^{ᵢₙ}^{(r,φ,z)} which is the far field of one mode in the incoming fiber into the far field of another mode in the output fiber Eₒᵤₜ(r,φ,z)=\sqrt{Iₒᵤₜ(r,φ,z)}e^{iφ}^{ₒᵤₜ}^{(r,φ,z)} where Iᵢₙ(r,φ,z),Iₒᵤₜ(r,φ,z) represents the intensity profile and φᵢₙ(r,φ,z),φₒᵤₜ(r,φ,z) represents the phase of the input and output field, respectively. One example could be a simple phase only optical element where one half of the plate is providing a half wave retardation, thus enabling coupling light between the symmetric LP₀₁ and the asymmetric LP₁₁:

$${I}_{in} ( r , ϕ ) = \{ \begin{matrix}{I}_{out} ( r , ϕ ) & for ϕ < π \\ {I}_{out} ( r , ϕ ) + π & for ϕ > π\end{matrix}$$

Since the intensity profiles Iᵢₙ(r,φ,z),Iₒᵤₜ(r,φ,z) do not match, the device will in general also couple a fraction of the light into undesired modes (either propagating modes or leaky modes, the latter leading to loss). The mismatch between the intensity profiles can be improved by introducing loss, which would minimize the coupling to unwanted modes however introducing additional loss is in many cases undesirable.

An alternative approach is to use an optical system comprising two wave front manipulating elements, which are known to be a low loss, efficient approach for transferring light between modes.

The present invention is not limited to the details of the above described principles. The scope of the invention is defined by the appended claims and all changes and modifications as fall within the equivalents of the scope of the claims are therefore to be embraced by the invention. Mathematical conversions or equivalent calculations of the signal values based on the inventive method or the use of analogue signals instead of digital values are also incorporated.

1. A method of transmitting optical signals over an optical fiber, the optical fiber having a first and a second mode of transmission, the method comprising the steps of:
transmitting a first optical signal at the first mode of transmission over a first portion of the optical fiber;
transmitting a second optical signal at the second mode of transmission over the first portion of the optical fiber;
transmitting the first optical signal at the second mode of transmission over a second portion of the optical fiber; and
transmitting the second optical signal at the first mode of transmission over the second portion of the optical fiber.

2. The method according to claim 1, further comprising the steps of:
converting the first mode of transmission to the second mode of transmission; and
converting the second mode of transmission to the first mode of transmission.

3. The method according to claim 2, wherein the conversion of the first mode of transmission to the second mode of transmission and the conversion of the second mode of transmission to the first mode of transmission occurs within a network element.

4. The method according to claim 3 wherein the network element is an amplifier site.

5. The method of claim 1, wherein the first portion of the optical fiber has substantially the same transmission characteristics as the second portion of the optical fiber.

6. A method for reducing group modal delay in a multimode transmission line having N optical signals and N modes of transmission, the method comprising the steps of:
receiving the N optical signals from N transmitters, propagating the N optical signals in the N modes of transmission; and
converting the N modes at N positions along the transmission line to equalize the difference in modal group delay generated between the N modes, such that at the end of the transmission line, each of the N optical signals will arrive approximately simultaneously.

7. The method of claim 6 wherein the step of converting further comprises converting each of the N modes at approximately equal positions along the transmission line.

8. A system for transmitting a number, N, of optical signals over a transmission line comprising:
N transmitters;
at least one span of a multimode fiber wherein the multimode fiber has N modes;
N mode converters positioned at N places along the transmission line; and
N receivers.

9. The system of claim 8 operating according to a method comprising the steps of:
receiving each of the N optical signals from each of the N transmitters;
propagating each of the N optical signals in each of the N modes of transmission; and
converting each of the N modes at each of the N mode converters to equalize a difference in modal group delay generated between the N modes, such that at the end of the transmission line, each of the N optical signals will arrive approximately simultaneously.

10. The system of claim 8, wherein at least one of the N mode converters is a transverse transformer.

11. The system of claim 10, wherein the transverse transformer is selected from the group consisting of holographic plates and phase sensitive elements.

12. The system of claim 8, wherein at least one of the N mode converters is a longitudinal transformer.

13. The system of claim 12, wherein at least one of the N mode converters is a long period grating.

14. The system of claim 8 wherein the at least span of one multimode fiber is a few mode fiber.
